(19) United States
(12) Patent Application Publication
(10) Pub. No.: US 2014/0049654 A1
(43) Pub. Date: Feb. 20, 2014

(54) INFORMATION PROVIDING SYSTEM, INFORMATION PROVIDING DEVICE, IMAGE CAPTURE DEVICE, AND COMPUTER PROGRAM

(71) Applicant: PANASONIC CORPORATION, OSAKA (JP)

(72) Inventor: Takanori Okada, Osaka (JP)

(21) Appl. No.: 13/980,591

(22) PCT Filed: Dec. 13, 2012
(86) PCT No.: PCT/JP2012/007971

§ 371 Date: Jul. 19, 2013

(30) Foreign Application Priority Data
Mar. 12, 2012 (JP) 2012-054157

(51) Int. Cl. H04N 5/232

(52) U.S. Cl. CPC H04N 5/23222
USPC 348/207.1

(57) ABSTRACT

An information providing method includes: obtaining first information indicating a position and direction of image capture device; obtaining, based on the first information, second information indicating geography and layout of buildings in surroundings of the image capture device; obtaining, based on the first information, third information indicating at least one of a running status of a public transportation system and a solar orbit; determining whether or not one of a shooting object and a non-shooting object is within a shooting range of the image capture device based on the first information to the third information; and displaying information indicating a result of the determination on a display.

### TECHNICAL FIELD

The present disclosure relates to an information providing system that includes an image capture device connectable to a network and an information providing device that provides information to the image capture device, and to a computer program to be used in this system.

### BACKGROUND ART

When shooting on location to obtain a video used in a movie or a TV drama, it is a common practice to research the circumstances of the location and actually visit the location in advance in order to determine whether the location is suitable for the scene intended to be shot. A preliminary check as this often precedes the carrying out of the shooting on the scheduled day because location shooting is greatly affected by the surrounding environment.

Various examples are known of systems that assist in location shooting by providing an image capture device (hereinafter also referred to as “camera”) with information about the surrounding environment from a server when the image capture device is used on location.

Patent Document No. 1 discloses an example in which an information terminal having a Global Positioning System (GPS) receiver accesses a server via a network to obtain, from the server, information about objects in scenery visible from the current position, and displays the information.

Patent Document No. 2 discloses an example in which a warning to a user of an image capture device is displayed by determining, based on information of the image capture device such as the current position, the orientation, and the tilt, and information about the current solar altitude, weather, and the like, whether the scene is backlit by the sun within the shooting range, which is determined by the field angle of the image capture device.

### CITATION LIST

### Patent Literature

Patent Document No. 1: Japanese Patent Application Laid-Open Publication No. 2006-285546
Patent Document No. 2: Japanese Patent Application Laid-Open Publication No. 2008-180840

### SUMMARY OF INVENTION

### Technical Problem

The present disclosure provides a new technique that enables a user to grasp various types of information for assisting in shooting on location in advance.

### Solution to Problem

An information providing device according to one embodiment of the present disclosure includes: an obtaining section that obtains first information indicating a position and direction of an image capture device; and a control section that obtains, from a storage medium, based on the first information, second information indicating geography and layout of buildings in surroundings of the image capture device, and third information indicating at least one of a running status of a public transportation system and a solar orbit, determines whether or not one of a shooting object and a non-shooting object is within a shooting range of the image capture device based on the first information to the third information, and outputs information indicating a result of the determination.

### Advantageous Effects of Invention

According to the present disclosure, it is possible to enable the user to grasp the various types of information for assisting in the shooting on location in advance.

### BRIEF DESCRIPTION OF DRAWINGS

FIG. 1 is a diagram illustrating the overall configuration of an information providing system according to an exemplary embodiment.

FIG. 2A is a block diagram illustrating the configuration of an image capture device 10 according to the exemplary embodiment.

FIG. 2B is a block diagram illustrating the configuration of an information providing device 30 according to the exemplary embodiment.

FIG. 3 is a flow chart illustrating the operation of the information providing system according to the exemplary embodiment.

FIG. 4 is a diagram illustrating an example of processing of determining whether or not the sun is within a shooting range.

FIG. 5 is a table showing shooting object/non-shooting object patterns and examples of the specifics of determination.

FIG. 6 is a diagram illustrating the overall configuration of an information providing system according to first to fourth exemplary embodiments.

FIG. 7 is a block diagram illustrating the configuration of a camera according to the first exemplary embodiment.

FIG. 8 is a flow chart illustrating public transportation system determining processing which is executed by an information providing server according to the first exemplary embodiment.

FIG. 9 is a block diagram illustrating the configuration of a camera according to the second and third exemplary embodiments.

FIG. 10 is a flow chart illustrating backlit shooting determining processing which is executed by an information providing server according to the second exemplary embodiment.

FIG. 11 is a flow chart illustrating sunrise determining processing which is executed by an information providing server according to the third exemplary embodiment.

FIG. 12 is a block diagram illustrating the configuration of a camera according to the fourth exemplary embodiment.

FIG. 13 is a flow chart illustrating shade determining processing which is executed by an information providing server according to the fourth exemplary embodiment.

FIG. 14 is a block diagram illustrating the configuration of an information providing device according to another embodiment.

FIG. 15 is a flow chart illustrating determining processing which is executed by the information providing device according to the another embodiment.

### DESCRIPTION OF EMBODIMENTS

Embodiments are described in detail below with reference to the respectively appropriate drawings. Descriptions more detailed than necessary, however, may be omitted. For instance, a detailed description on a well-known matter and a redundant description on substantially the same components are omitted in some cases. This is to avoid lengthening the following description unnecessarily and to facilitate the understanding of a person skilled in the art.

The inventor of the present disclosure provides the accompanying drawings and the following description in order for a person skilled in the art to fully understand the present disclosure, and these are not to limit the idea described in the scope of claims.

Before specific embodiments are described, a description on problems of conventional technologies that are solved by embodiments of the present disclosure is given first as well as the outline of the embodiments disclosed herein.

When shooting on location in order to obtain a video used in a TV program or a movie, there are cases where, in spite of a preliminary check, an accident on the day of location shooting forces a camera crew to stop shooting or change location. One of such cases is the interruption of shooting caused by the operation of a public transportation system. Specifically, noise from an airplane flying over the location during shooting can stop the shooting, a train or bus passing nearby can hinder and stop the shooting, and an airplane, train, or bus passing through the perimeter can be captured accidentally in the background of a video being shot.

There are also cases where sunlight greatly affects location shooting. Specifically, a location that has been sunny in the preliminary check can be in the shadow of a building at the time shooting takes place. Conversely, there can be a case where the sky has been cloudy at the time of the preliminary check and the location turns out to be a backlit place on the day of shooting when the sky is clear. Various other factors can necessitate the interruption of shooting and a sudden change of location. These problems cannot be avoided with the methods disclosed in Patent Document Nos. 1 and 2.

On the other hand, there may also be cases where a vehicle of a public transportation system, the sun, a shaded place, or the like is actively sought after for shooting. For instance, shooting an airplane or a train may be desired, shooting a sunrise or a sunset may be desired, and shooting a scene with the main subject in the shade may be desired. In such cases, there is a chance in spite of a preliminary check that a desired object cannot be shot as planned because of a difference in time of the day, weather, or the like between the preliminary check and the actual shooting. In order to shoot successfully at the scheduled time, the preliminary check needs to be thorough.

The inventor of the present disclosure has found out the problems described above and completed the technique of the present disclosure. According to an embodiment of the present disclosure, the interruption of shooting or a change of location can be prevented by enabling a user to grasp various types of information for assisting in shooting on location at the time of the shooting or prior to the shooting. According to another embodiment, a user knows whether or not an object that the user wishes to film is going to be shot properly, and the preliminary thorough check can therefore be simplified.

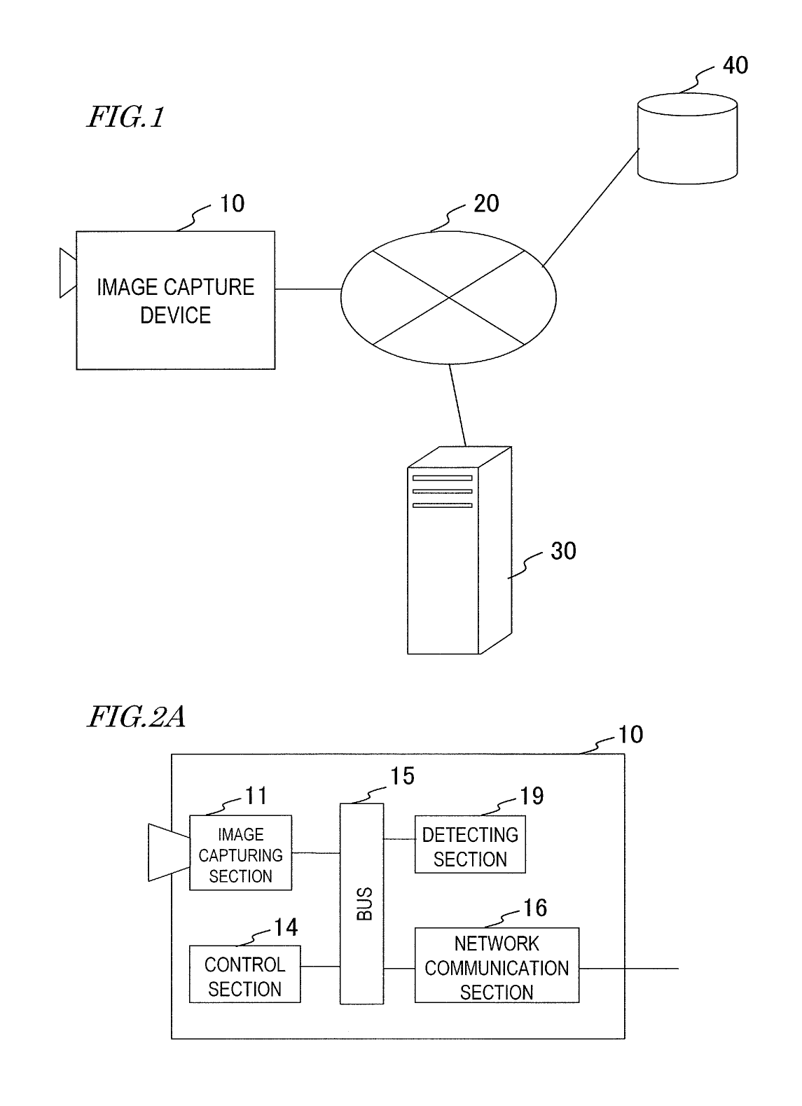

FIG. 1 is a diagram illustrating the overall configuration of an information providing system according to an embodiment. This information providing system includes an image capture device 10 and an information providing device 30 that are connected in a manner that allows communication to and from each other over a computer network 20. FIG. 1 also illustrates a storage medium 40, which is an external component of the information providing system. In this embodiment, the image capture device 10 can be, for example, a digital video camera that obtains video data on location. The information providing device 30 can be a computer such as a server computer set up in a place that is not the site of location shooting (for example, a studio). The storage medium 40 stores information that indicates the geography and the spatial layout of buildings (for example, three-dimensional map data) and information that indicates at least one of the running status of a public transportation system and the solar orbit. These pieces of information may be stored while being distributed among a plurality of recording media.

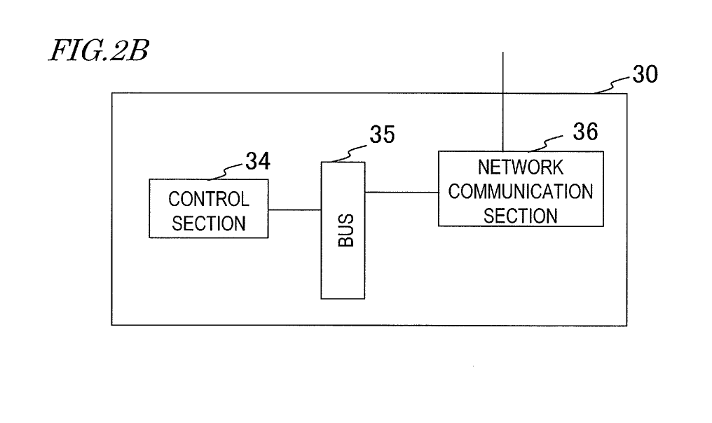

FIG. 2A is a block diagram illustrating the schematic configuration of the image capture device 10. The image capture device 10 includes an image capturing section 11 that obtains video data by filming, a detecting section 19 that detects the position and direction of the image capture device 10, a network communication section 16 that communicates via the network 20, and a control section 14 that controls the overall operation of the image capture device 10. These components are connected so that electrical signals are transmitted to and from one another via a bus 15. Though not illustrated in FIG. 2A, the image capture device 10 may include other components such as an operation section (user interface) that receives an operation of a user, a displaying section (display) that displays the obtained video or various types of information, and a storage medium.

FIG. 2B is a block diagram illustrating the schematic configuration of the information providing device 30. The information providing device 30 includes a network communication section 36 that communicates information over the network 20, and a control section 34 that controls the overall operation of the information providing device 30. The control section 34 and the network communication section 36 are connected so that electrical signals are transmitted to and from each other via a bus 35. Though not illustrated in FIG. 2B, the information providing device 30 may include other components such as an operation section (user interface) that receives an operation of a user, and a storage medium for recording various types of data received by the network communication section 36.

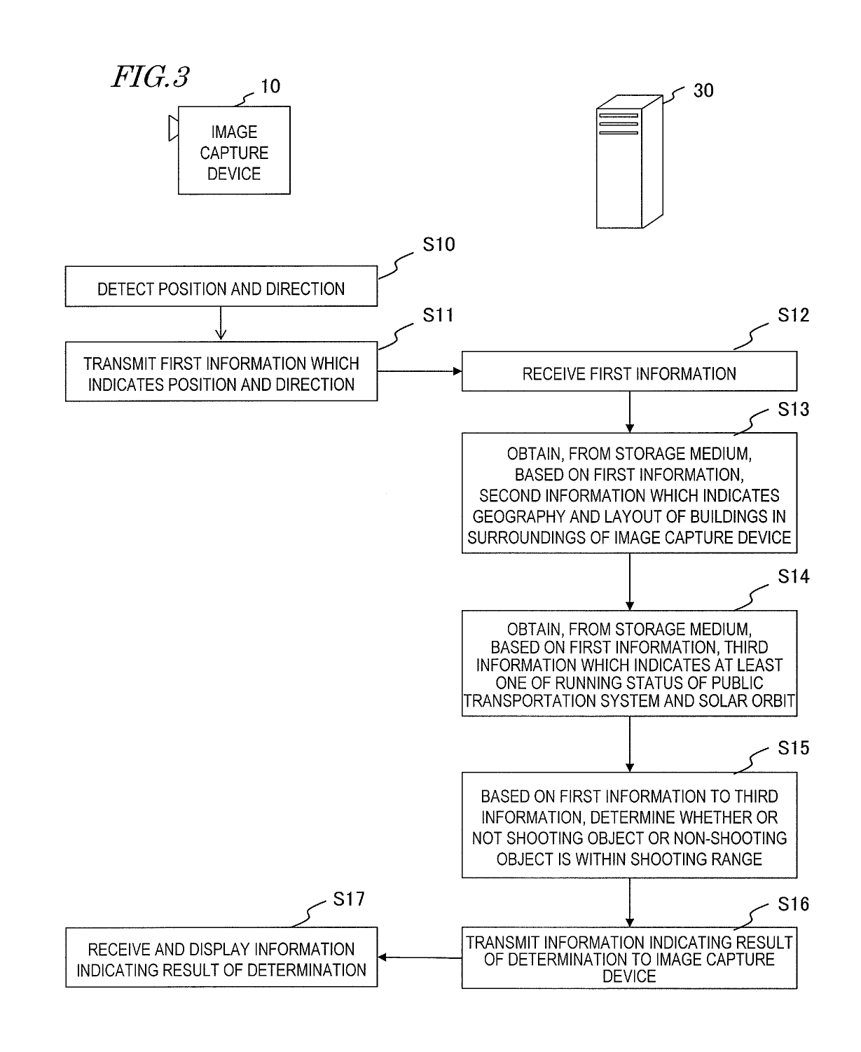

FIG. 3 is a flow chart illustrating the flow of the overall operation of the image capture device 10 and the information providing device 30. First, the image capture device 10 detects the position and direction of the image capture device 10 in Step S10. The detection is conducted by the detecting section 19. The position of the image capture device 10 is identified from three-dimensional coordinates (e.g., latitude, longitude, and altitude), and a GPS receiver, for example, can be used for the detection. The direction of the image capture device 10 is identified from the orientation and the elevation angle. A magnetic compass and an acceleration sensor, for example, can be used to detect the orientation and the elevation angle, respectively. The detecting section 19 is a component that includes these GPS receiver, magnetic compass, and acceleration sensor. Next, in Step S11, the control section 14 in the image capture device 10 transmits first information which indicates the detected position and direction of the image capture device 10 via the network communication section 16. The control section 14 at this point may include information that indicates the field angle of the image capture device 10 in the transmission of the first information. The field angle is the range of a space shot by the image capture device 10 that is expressed in angle, and is determined by the focal length of the lens and the size of the image pickup device. If the control section 14 transmits information that indicates the field angle, the shooting range of the image capture device 10 can be conveyed more accurately to the information providing device 30.

In the subsequent Step S12, the network communication section 36 in the information providing device 30 receives the information sent from the image capture device 10. In Step S13, the control section 34 in the information providing device 30 obtains second information, which indicates the geography and the spatial layout of buildings in the surroundings of the image capture device 10, from the storage medium 40, based on the received first information. The storage medium 40 stores a database that contains information about the geography (including information on mountains, rivers, oceans, and trees) and about the layout of buildings in the three-dimensional space (hereinafter may be referred to as “surrounding environment database”). Out of information contained in the surrounding environment database, the control section 34 obtains information about the surroundings of the image capture device 10 as the second information. The “surroundings” here can stretch to, for example, a radius of several tens meters to several kilometers, though depending on shooting conditions and shooting objects.

In the subsequent Step S14, the control section 34 obtains third information, which indicates at least one of the running status of a public transportation system and the solar orbit, from the storage medium 40, based on the first information. The storage medium 40 stores a database that contains information about at least one of the running status of a public transportation system (airplanes, trains, buses, or the like) and the solar orbit. Out of information contained in this database, the control section 34 obtains, as the third information, information about at least one of a public transportation system and the sun that has a possibility of affecting shooting with the image capture device 10 at the current position. The third information depends on an object planned to be shot with the image capture device 10 (hereinafter may be referred to as “shooting object”) and an object planned to avoid shooting with the image capture device 10 (hereinafter may be referred to as “non-shooting object”). For instance, in a use where shooting a vehicle of a public transportation system is avoided, the vehicle of the public transportation system is the “non-shooting object” and information indicating the running status of the public transportation system is obtained as the third information. In a use where a sunrise is shot, on the other hand, the sun is the “shooting object” and information indicating the solar orbit is obtained as the third information. The shooting object and the non-shooting object vary from one embodiment to another, and various modes are feasible. Patterns of the shooting object and the non-shooting object are described later.

In the subsequent Step S15, the control section 34 determines whether or not the shooting object or the non-shooting object is within the shooting range based on the obtained first to third information. The “shooting range” means a range in the three-dimensional space that is displayed in a video obtained through shooting with the image capture device 10. For instance, when the sun is situated outside a range defined by the field angle of the image capture device 10, the sun is outside the shooting range at that time. Even when the sun is situated inside the range defined by the field angle, if blocked by a physical object such as a mountain or a building and not shown on the video, the sun is outside the shooting range at that time. In the following description, a physical object being situated within the shooting range may be expressed as “being captured in the shot”.

When the non-shooting object is a vehicle of a public transportation system, for example, the control section 34 determines whether or not the vehicle of the public transportation system is within the shooting range. When the shooting object is a sunrise, the control section 34 determines whether or not the sun is within the shooting range. The control section 34 thus performs determining processing suited to the shooting object and the non-shooting object. These are determined in a comprehensive manner from the position and direction of the image capture device 10, the geography and the spatial layout of buildings in the surroundings of the image capture device 10, and the movement of a vehicle of a public transportation system and/or of the sun, based on the first to third information. For instance, the control section 34 identifies a range that is defined by the field angle of the image capture device 10 based on the position and direction of the image capture device 10 and, from the positional relation of the shooting object (or the non-shooting object) to mountains, trees, or buildings that are within the shooting range, determines whether or not the shooting object (or the non-shooting object) is going to appear on the shot.

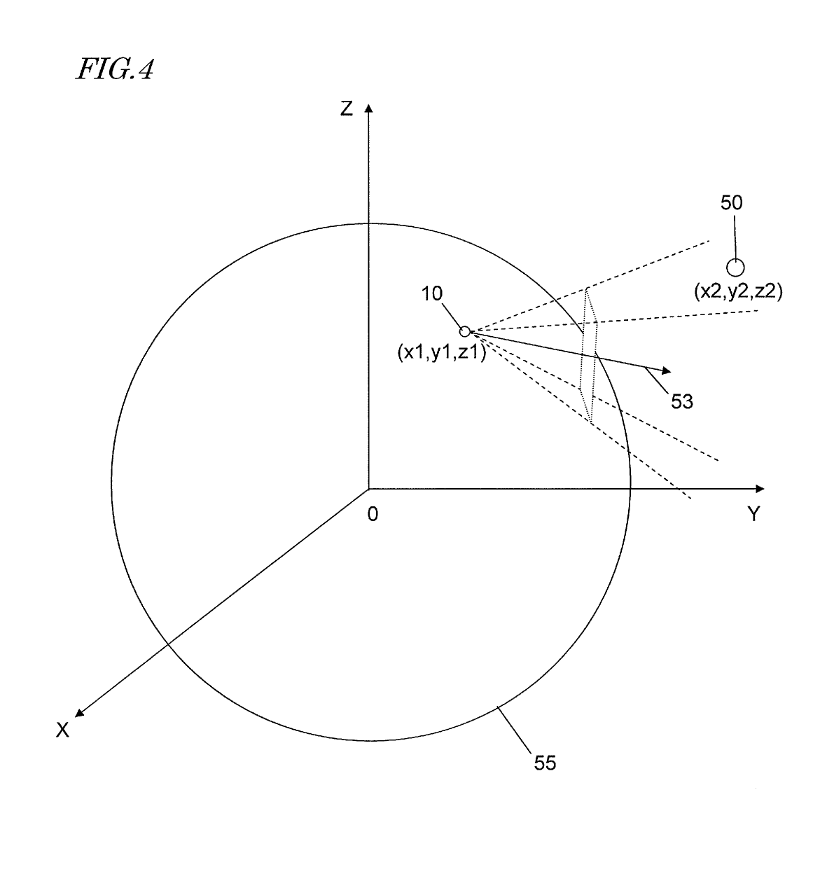

FIG. 4 is a conceptual diagram illustrating an example of this determining processing. A case where the shooting object is the sun 50 is assumed here. The control section 34 identifies the coordinates of the image capture device 10, (x1, y1, z1), in a three-dimensional coordinate system that is defined by an X-axis, a Y-axis, and a Z-axis and has the center of the earth 55 as the origin. The control section 34 also identifies the coordinates of the sun 50, (x2, y2, z2), and the coordinates of mountains, trees, buildings, and the like (not shown) in the surroundings of the image capture device 10. The coordinates of the image capture device 10 are obtained by conversion from information about the latitude, the longitude, and the altitude. From a vector 53, which indicates the direction of the image capture device 10, and from information indicating the field angle, the control section 34 identifies a range in the three-dimensional space (the range surrounded by four broken lines in FIG. 4) that has a possibility of being within the shooting range. The control section 34 then refers to data about the geography and buildings and data about the position of the sun to determine whether or not the sun 50 is within the shooting range without being blocked by mountains, trees, buildings, and the like. This determining processing is an example, and the control section 34 may use other methods to determine.

In the subsequent Step S16, the control section 34 transmits information indicating the result of the determination to the image capture device 10 via the network communication section 36. In Step S17, the image capture device 10 receives the information indicating the result of the determination via the network communication section 16, and the control section 14 displays the result of the determination on the displaying section.

Through the operation described above, the user of the image capture device 10 is informed of whether the “shooting object” which the user wishes to film or the “non-shooting object” which the user does not wish to film is within the shooting range (whether or not the object is going to appear on the shot).

Determination made by the control section 34 in the information providing device 30 is not limited to the determination described above, and the control section 34 may perform various types of determination processing suited to the type of the shooting object or the non-shooting object to notify the result thereof to the image capture device 10. Typical shooting object/non-shooting object patterns and examples of the specifics of determination are described below.

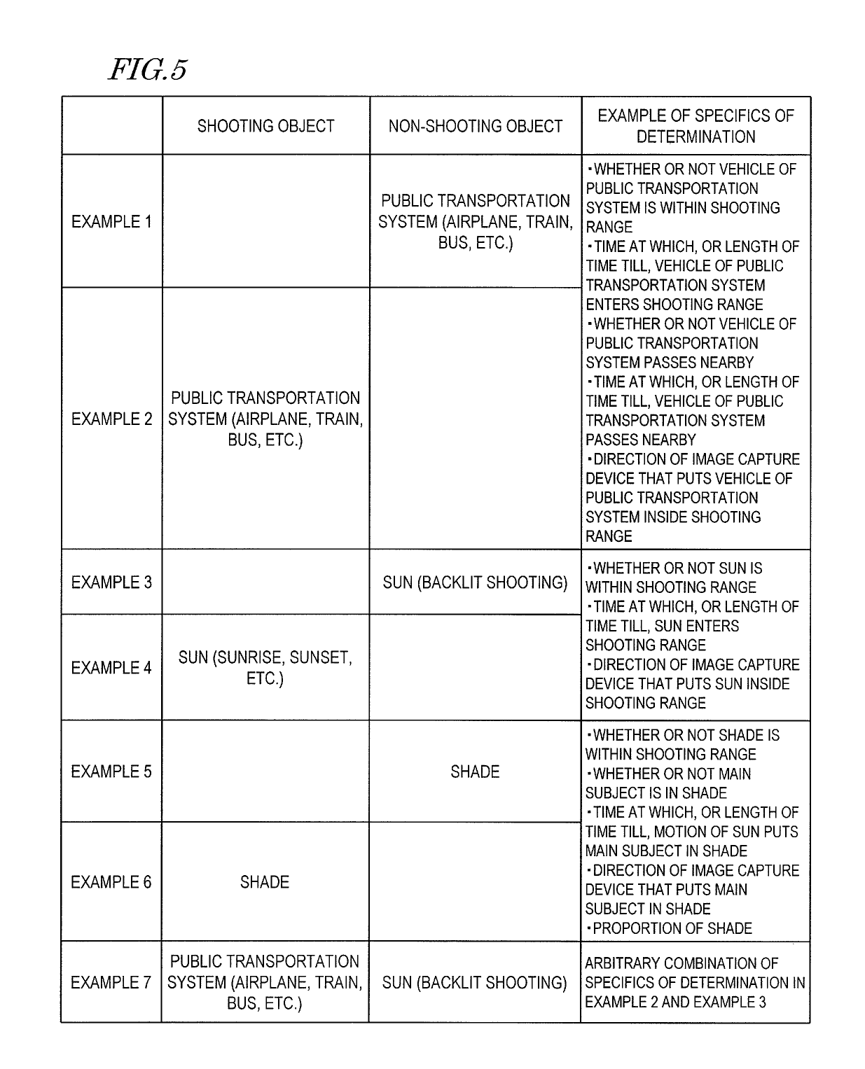

FIG. 5 is a table showing typical examples of the “shooting object” and the “non-shooting object” and an example of the specifics of determination in each of the examples. Example 1 is an example of the case where the non-shooting object is a vehicle of a public transportation system (an airplane, a train, a bus, or the like). Example 2 is an example of the opposite case where the shooting object is a vehicle of a public transportation system. The specifics of determination in Examples 1 and 2 can be, for example, (i) whether or not the vehicle of the public transportation system is within the shooting range, (ii) the time at which the vehicle of the public transportation system enters the shooting range or the length of time till the vehicle enters the shooting range, (iii) whether or not the vehicle of the public transportation system passes nearby, (iv) the time at which the vehicle of the public transportation system passes nearby or the length of the time till the vehicle passes nearby, and (v) the direction of the image capture device that puts the vehicle of the public transportation system inside the shooting range. The control section 34 determines about these matters and notifies the result of the determination to the image capture device 10, thereby enabling the user to take actions to avoid shooting the vehicle of the public transportation system or actions to shoot the vehicle of the public transportation system intentionally.

Example 3 is an example of the case where the non-shooting object is the sun, in other words, the case where backlit shooting is to be avoided. Example 4 is an example of the opposite case where the sun is the shooting object, e.g., when a sunrise, a sunset, a solar eclipse, or the like is to be shot intentionally. The specifics of determination in Examples 3 and 4 can be, for example, (i) whether or not the sun is within the shooting range, (ii) the time at which the sun enters the shooting range or the length of time till the sun enters the shooting range, and (iii) the direction of the image capture device that puts the sun inside the shooting range. The control section 34 determines about these matters and notifies the result of the determination to the image capture device 10, thereby enabling the user to take actions to avoid backlit shooting or actions to intentionally shoot a sunrise or a sunset.

Example 5 is an example of the case where the non-shooting object is a shade. Example 6 is an example of the opposite case where the shooting object is a shade. The specifics of determination in Examples 5 and 6 can be, for example, (i) whether or not a shade is within the shooting range, (ii) whether or not the main subject is going to be in a shade, (iii) the time at which the motion of the sun puts the main subject in a shade or the length of time till the motion of the sun puts the main subject in a shade, (iv) the direction of the image capture device that puts the main subject in a shade, and (v) the proportion of the shade to the entire screen. The control section 34 determines about these matters and notifies the result of the determination to the image capture device 10, thereby enabling the user to take actions to avoid shooting a shade or actions to intentionally shoot a shade.

Example 7 is an example of the case where the shooting object and the non-shooting object both are set. In this example, a vehicle of a public transportation system is set as the shooting object and the sun is set as the non-shooting object. The specifics of determination in Example 7 can be an arbitrary combination of the specifics of determination in Example 2 and Example 3. The control section 34 determines about those matters and notifies the result of the determination to the image capture device 10, thereby enabling the user to take actions to film the vehicle of the public transportation system while avoiding shooting the vehicle backlit. The shooting object and the non-shooting object can thus be set both. Although Example 7 assumes the case where a vehicle of a public transportation system is shot intentionally and backlit shooting is avoided, other combinations of the shooting object and the non-shooting object can be used.

As described above, according to the information providing system of this disclosure, various matters including whether or not the shooting object or the non-shooting object is within the shooting rage are determined based on information about the position and direction of the image capture device, the geography, buildings, public transportation systems, or the sun, and the results of the determination are notified to the image capture device. The information providing device can thus provide such information as how many minutes there are till a vehicle of a public transportation system, e.g., an airplane, a train, or a bus, passes through the shooting range to the user before shooting starts. Consequently, situations such as being forced to stop shooting can be prevented and efficient filming work is accomplished. The information providing system can also provide to the user, in advance, such information as whether the location is in a shade, or whether the location is backlit, at the scheduled date/time of shooting. Situations such as undergoing a change of location on the day of shooting can be prevented and efficient filming work is accomplished. Moreover, in the case where a vehicle of a public transportation system, a sunrise, or the like is to be shot intentionally, preparations can be simplified because an appropriate shooting time and an appropriate direction of the image capture device are grasped in advance.

More specific embodiments of the present disclosure are described below.

### First Embodiment

A first embodiment is described first. This embodiment relates to an information providing system that provides various types of information to a user in order to prevent an image capture device from accidentally capturing a vehicle of a public transportation system in the shot. In this embodiment, the user is provided with various types of information about a vehicle of a public transportation system that is the “non-shooting object”.

[1-1. Configuration]

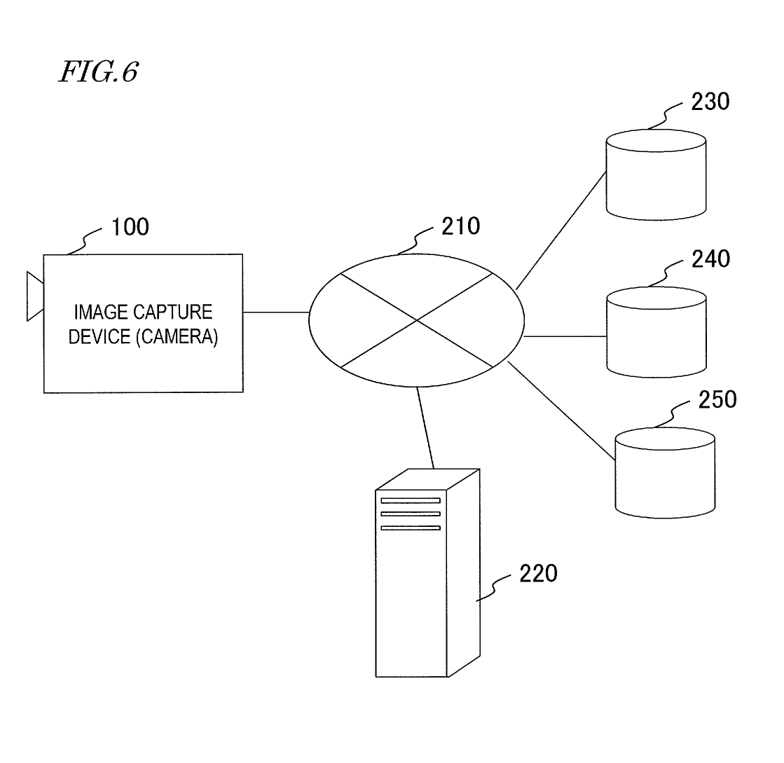

FIG. 6 is a diagram illustrating the overall configuration of an information providing system according to this embodiment. This information providing system includes a digital video camera (hereinafter simply referred to as “camera”) 100 and an information providing server 220, which are connected in a manner that allows communication to and from each other over a network 210. A plurality of recording media for storing a map database 230, a building database 240, and a public transportation system database 250 are also connected to the network 210.

The network 210 of FIG. 6 is, for example, a public network such as the Internet, or a leased line and connects the camera 100 and the information providing server 220. The camera 100 is capable of transmitting via the network 210 information about the position, direction, and field angle of the camera 100 to the information providing server 220. The information providing server 220 can access the map database 230, the building database 240, and the public transportation system database 250 via the network 210.

The information providing server 220 is a server computer (information processing device) that corresponds to the information providing device 30 in the description given above. The configuration of the information providing server 220 is the same as the one illustrated in FIG. 2B. The information providing server 220 obtains the information about the position, direction, and field angle of the camera 100 to determine whether or not a vehicle of a public transportation system that is the non-shooting object is within the shooting range of the camera 100 (whether or not the vehicle is going to be captured in the shot), and notifies the result of the determination to the camera 100. When determining this, the information providing server 220 obtains necessary information from the map database 230, the building database 240, and the public transportation system database 250.

The map database 230 provides a map and geographical data in an arbitrary spot. The building database 240 provides data about the shapes and sizes of buildings which is data indicating the spatial layout in a three-dimensional coordinate system. The public transportation system database 250 provides real-time running status data such as the current whereabouts of a traveling vehicle of a public transportation system, e.g., a train, a bus, or an airplane. The map database 230 and the public transportation system database 250 may be integrated as a three-dimensional map database.

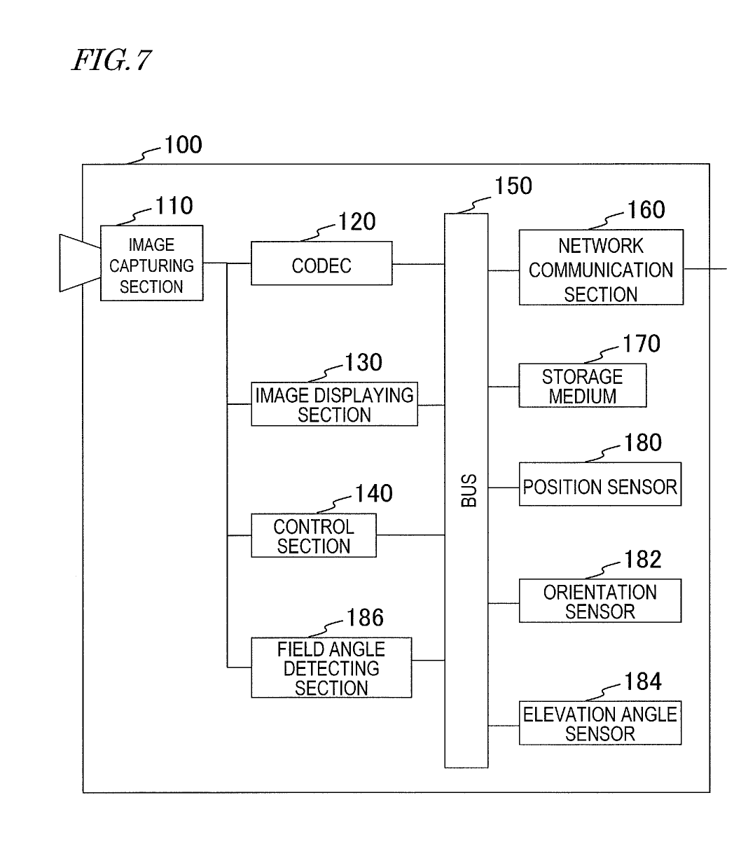

FIG. 7 is a block diagram illustrating the configuration of the camera 100 according to this embodiment. The camera 100 includes an image capturing section 110, a codec 120, an image displaying section 130, a control section 140, a bus 150, a network communication section 160, a storage medium 170, a position sensor 180, an orientation sensor 182, an elevation angle sensor 184, and a field angle detecting section 186. The image capturing section 110 includes an optical system such as a lens and an image pickup device such as a charge-coupled device (CCD) or complementary metal-oxide-semiconductor (CMOS) sensor. The image capturing section 110 is connected to the codec 120, the image displaying section 130, the control section 140, and the field angle detecting section 186. The codec 120, the image displaying section 130, the control section 140, the network communication section 160, the storage medium 170, the position sensor 180, the orientation sensor 182, the elevation angle sensor 184, and the field angle detecting section 186 are each connected to the bus 150 to transmit electrical signals to one another.

The codec 120 is a circuit that compresses/decompresses a video signal generated by the image capturing section 110 and outputs the signal. The image displaying section 130 is a display capable of displaying an obtained video and various types of setting information. The control section 140 is a processor that controls the overall operation of the camera 100, such as a central processing unit (CPU) or a microcomputer. The control section 140 controls the respective sections by executing a control program. The storage medium 170 is a memory such as a DRAM, and stores the control program executed by the control section 140 and various types of data generated in the process of computing. The control section 140 may be implemented by a combination of hardware such as an integrated circuit and software (a program), or may be implemented by hardware alone.

The network communication section 160 is a network interface capable of transmitting and receiving information over the network 210. The field angle detecting section 186 is a detection mechanism for identifying the field angle based on the zoom value and the size of the image pickup device in the image capturing section 110. The position sensor 180 is a sensor that detects the position of the camera 100 and can be implemented by, for example, a receiver that receives GPS signals. The orientation sensor 182 is a sensor that detects the orientation of the camera 100 and can be implemented by, for example, a magnetic compass. The elevation angle sensor 184 is a sensor that detects the elevation angle of the camera 100 and can be implemented by, for example, an acceleration sensor.

The camera 100 can include, in addition to the components described above, other components (not shown). For instance, the camera 100 may include an operation panel which is operated by the user, a power supply circuit which supplies power to the respective sections, a camera shake correcting mechanism, a microphone, an audio processing circuit, and a speaker. The camera 100 can have any configuration as long as the following operation can be carried out.

[1-2. Operation]

The operation of the camera 100 configured as above is described. Video signals obtained by the image capturing section 110 are compressed by the codec 120. The compressed video data is transferred via the bus 150 to the storage medium 170 to be recorded as a video file. The control section 140 exerts control on the transfer of the video data via the bus 150 and on the operation of recording the video data as a file. Through the operation described above, the camera 100 records video. Audio has low relevance to the technique of this embodiment, and a description about audio recording is omitted. The camera 100 can use known technologies to record audio.

The camera 100 can identify the camera's current position by receiving, for example, GPS signals with the use of the position sensor 180. The camera 100 can also identify an orientation in which the camera is pointed (the angle in the horizontal direction) with the use of the orientation sensor 182. The camera 100 can further identify the elevation angle in a direction in which the camera 100 is pointed (the angle in the vertical direction) with the use of the elevation angle sensor 184. Using the field angle detecting section 186, the camera 100 detects the zoom value and the optical value from the optical system of the image capturing section 110, such as a lens and a sensor, and identifies the field angle at which the shot is taken.

The network communication section 160 connects the camera 100 to the network 210 by cable or wireless connection. The camera 100 can transmit, through the network communication section 160, data detected by the sensors of the camera 100 to the network 210.

The control section 140 in the camera 100 transmits, via the network communication section 160, data detected respectively by the position sensor 180, the orientation sensor 182, the elevation angle sensor 184, and the field angle detecting section 186 to the network 210. The data transmitted from the camera 100 is transmitted to the information providing server 220 via the network 210.

The information providing server 220 first accesses the map database 230 of FIG. 6 based on position information detected by the position sensor 180 of FIG. 7 to obtain map data of the vicinity of where the camera 100 is located. For instance, the information providing server 220 obtains map data of an area within a radius of several hundred meters to several kilometers from the position of the camera 100.

The information providing server 220 next identifies buildings that may be captured in the shot taken with the camera 100 (be within the shooting range) based on the obtained map data, orientation information detected by the orientation sensor 182 of FIG. 7, elevation angle information detected by the elevation angle sensor 184 of FIG. 7, and field angle information detected by the field angle detecting section 186 of FIG. 7. The information providing server 220 then obtains data about the spatial layout in the three-dimensional space of the buildings that may be captured in the shot from the building database 240. The information providing server 220 can consequently grasp the sizes and positional relation of the buildings that may be captured in the shot. This revelation of the fact that buildings, rail tracks, roads, the sky, or the like is within the field angle range of the video, combined with the map data described above, enables the information providing server 220 to identify which public transportation system's vehicle is going to be captured in the video.

The information providing server 220 next accesses the public transportation system database 250 with respect to the identified public transportation system's vehicle to obtain information about the real-time whereabouts of a traveling train, bus, airplane, or the like. With the current whereabouts of the identified public transportation system's vehicle thus found out, the information providing server 220 can grasp in advance how many minutes there are till a train, a bus, an airplane, or the like passes through the current field angle range of the camera 100.

The information providing server 220 transmits, via the network 210, to the camera 100, information about the detected passing of a vehicle of a public transportation system. The control section 140 in the camera 100 obtains this information via the network communication section 160. Based on the received information, the control section 140 displays the information about the passing of a vehicle of a public transportation system on the image displaying section 130. The user of the camera 100 can thus be notified in advance of the fact that a train, a bus, an airplane, or the like is going to be captured in the video.

Processing executed by the information providing server 220 of FIG. 6 is described next with reference to a flow chart.

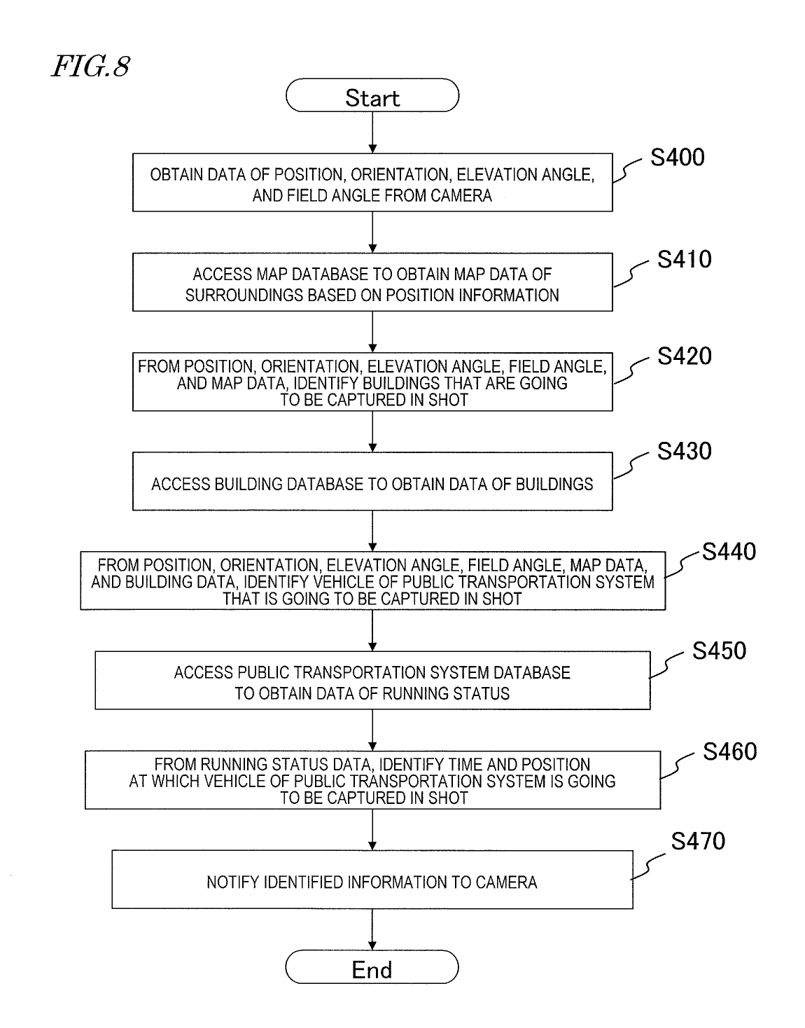

FIG. 8 is a flow chart illustrating determining processing that is executed with regard to a vehicle of a public transportation system by the information providing server 220. In Step S400, the information providing server 220 holds communication to and from the camera 100 over the network 210 to obtain data of the current position, orientation, elevation angle, and field angle of the camera 100. These pieces of data correspond to the first information in the example of FIG. 4. In Step S410, the information providing server 220 next accesses the map database 230 via the network 210 to obtain map data of the surroundings of the camera 100 based on the information of the current position of the camera 100. In Step S420, the information providing server 220 identifies buildings that are going to be captured in the shot based on the current position, orientation, elevation angle, and the field angle of the camera and the map data of the surroundings obtained from the map database. In Step S430, the information providing server 220 accesses the building database 240 to obtain data of the buildings identified in Step S420. These map data and building data correspond to the second information in the example of FIG. 4. Next, in Step S440, the information providing server 220 identifies a vehicle of a public transportation system that is going to be captured in the shot based on the current position, orientation, elevation angle, and the field angle of the camera, the map data, and the building data. In Step S450, the information providing server 220 accesses the public transportation system database 250 to obtain the current running status of the public transportation system's vehicle identified in Step S440. The running status data includes the current whereabouts of the vehicle of the public transportation system. This data corresponds to the third information in the example of FIG. 4. Next, in Step S460, the information providing server 220 identifies a time and a position at which the vehicle of the public transportation system is going to be captured in the shot based on the running status data. Lastly, the information providing server 220 communicates to/from the camera 100 via the network 210 in Step S470 to notify the information identified in Step S460 to the camera 100. The processing described above is executed by the control section of the information providing server 220 illustrated in FIG. 6.

The control section 140 of FIG. 7 may display the information about the passing of a vehicle of a public transportation system on the image displaying section 130 in the form of a simple warning. Alternatively, a specific point on the screen may be displayed superimposed on the current video, or the length of time till the passing may be displayed.

[1-3. Effects and the Like]

As described, the information providing server 220 in this embodiment identifies a vehicle of a public transportation system that has a possibility of being captured in the shot taken with the camera 100 by utilizing information about the current position, orientation, elevation angle, and the field angle of the camera 100, and map information and building information of the surroundings of the camera 100. The information providing server 220 further refers to the running status of the vehicle of the public transportation system, to thereby determine how many minutes there are till a train, a bus, an airplane, or the like passes through the current field angle range of the camera 100, and provide information indicating the result of the determination to the camera 100. The user thus grasps how many minutes there are till these vehicles of public transportation systems pass through the field angle range of the camera 100 which is filming, and can avoid situations such as stopping shooting halfway.

This embodiment corresponds to Example 1 in FIG. 5. Therefore, the information providing server 220 may perform other determining operations of FIG. 5 in addition to the determining operations described above, and notify the results thereof to the camera 100. The information providing server 220 may first determine whether or not a vehicle of a public transportation system is within the shooting range so that other determining operations are executed depending on the result of this determination. For instance, when it is determined that a vehicle of a public transportation system is within the shooting range, the information providing server 220 notifies this result to the camera 100, and notifies the camera 100 of the length of time till the vehicle of the public transportation system enters the shooting range when it is determined that the vehicle of the public transportation system is not within the shooting range. Alternatively, the camera 100 may be notified of information about the time at which the vehicle of a public transportation system enters the shooting range and the direction of the camera 100 that puts the vehicle of the public transportation system inside the shooting range. With this much diverse information provided to the user, even more efficient shooting is accomplished.

The functions in this embodiment described above can also be used when shooting intentionally a scene in which a vehicle of a public transportation system passes across. Also in this case, the camera 100 and the information providing server 220 operate the same way as above.

### Second Embodiment

A second embodiment is described next. This embodiment deals with an information providing system that provides a user with information by detecting, in advance, sunlight in location shooting, in particular, sunlight shined from behind a subject, namely, backlight. In this embodiment, the user is provided with various types of information about sunlight that is the “non-shooting object”.

[2-1. Configuration]

The overall configuration of the information providing system in this embodiment is the same as the overall configuration of the first embodiment which is illustrated in FIG. 6. In this embodiment, however, a database about the orbit of sunlight is used instead of the public transportation system database 250. The database about the orbit of sunlight may be possessed by the information providing server 220 itself. The physical configuration of the information providing server 220 in this embodiment is the same as in the first embodiment, and a description thereof is omitted here.

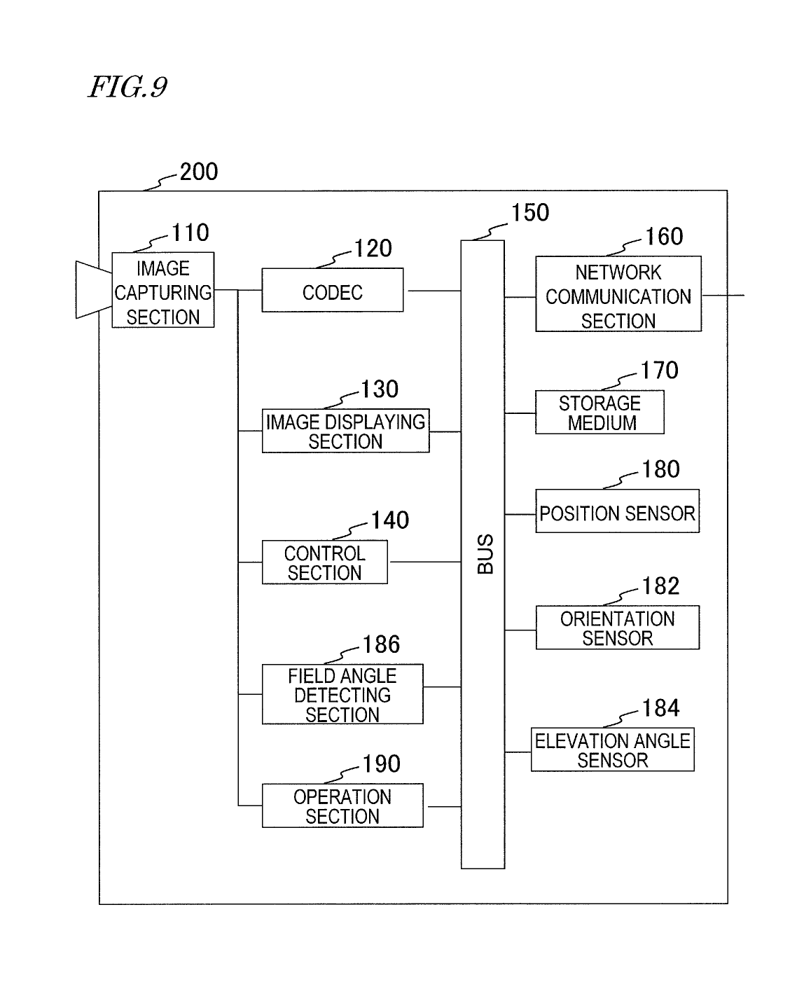

FIG. 9 is a block diagram illustrating the configuration of a camera 200 according to this embodiment. The camera 200 of this embodiment has, in addition to the components in the first embodiment, an operation section 190 (user interface), which is provided for a user to specify the shooting date/time. The operation section 190 can be implemented by, for example, operation buttons and a touch panel provided in the image displaying section 130. By operating the operation section 190, the user can specify a date/time scheduled for shooting. Other components than the operation section 190 are the same as those in the first embodiment described above, and descriptions thereof are omitted here.

[2-2. Operation]

The operation of the camera 200 and the information providing server 220 in this embodiment is described. The operation of shooting and recording video is the same as in the first embodiment described above, and a description thereof is omitted here.

The control section 140 in the camera 200 transmits, via the network communication section 160, data detected respectively by the position sensor 180, the orientation sensor 182, the elevation angle sensor 184, and the field angle detecting section 186 to the network 210. The data transmitted from the camera 200 is transmitted to the information providing server 220 via the network 210.

The information providing server 220 in this embodiment uses specified date/time information in addition to the information of the position, direction, and field angle of the camera 200. The specified date/time information is a date/time set by the user of the camera 200 of FIG. 9. With a date/time for actual shooting set by the user, the information providing server 220 checks how the sunlight looks at the specified shooting date/time. The control section 140 transmits, via the network communication section 160, the specified date/time information to the network 210. At this time, the specified date/time information transmitted from the camera 200 is transmitted to the information providing server 220 via the network 210.

The information providing server 220 first accesses the map database 230 of FIG. 6 based on position information detected by the position sensor 180 of FIG. 9 to obtain map data of the vicinity of where the camera 200 is located. For instance, the information providing server 220 obtains map data of an area within a radius of several hundred meters to several kilometers from the position of the camera 200.

The information providing server 220 next identifies buildings that may be captured in the shot taken with the camera 200 based on the obtained map data, orientation information detected by the orientation sensor 182, elevation angle information detected by the elevation angle sensor 184, and field angle information detected by the field angle detecting section 186. The information providing server 220 then obtains data about the spatial layout in the three-dimensional space of the buildings that may be captured in the shot from the building database 240. The information providing server 220 can consequently grasp the heights of buildings in the perimeter of a video shot with the camera 200 and the positional relation of the buildings to the camera.

The information providing server 220 next uses the camera position information detected by the position sensor 180 and the specified date/time information set by the user which is described above to obtain the position of the sun. The orientation and elevation angle of the sun can be identified if the position information and the date/time information are known.

The information providing server 220 compares the information of the identified orientation and elevation angle of the sun with the data of the orientation, elevation angle, and field angle of the camera 200 to determine whether or not the sun is within the field angle of the camera. If the sun is within the field angle of the camera, there is a possibility that the location is backlit. At this point, the information providing server 220 in this embodiment which knows the heights and positional relation of the surrounding buildings can further determine cases where the buildings block the sun and the location is not backlit as a result. For instance, even when there is a chance that the sun is captured in the background of a video to be shot, the shot does not actually capture the sun in the background of the video and is not backlit in some cases because of tall buildings or the like. The information providing server 220 is capable of accurately determining whether or not the sun is within the shooting range in such cases, too.

The information providing server 220 transmits the results of these determining operations as backlit shooting information to the camera 200 via the network 210. The control section 140 in the camera 200 of FIG. 9 obtains the backlit shooting information via the network communication section 160. The control section 140 displays the backlit shooting information on the image displaying section 130 based on the received backlit shooting information, thereby notifying the user of the camera 200 of whether or not the shot is going to be backlit at the specified date/time due to the sun captured in the shot.

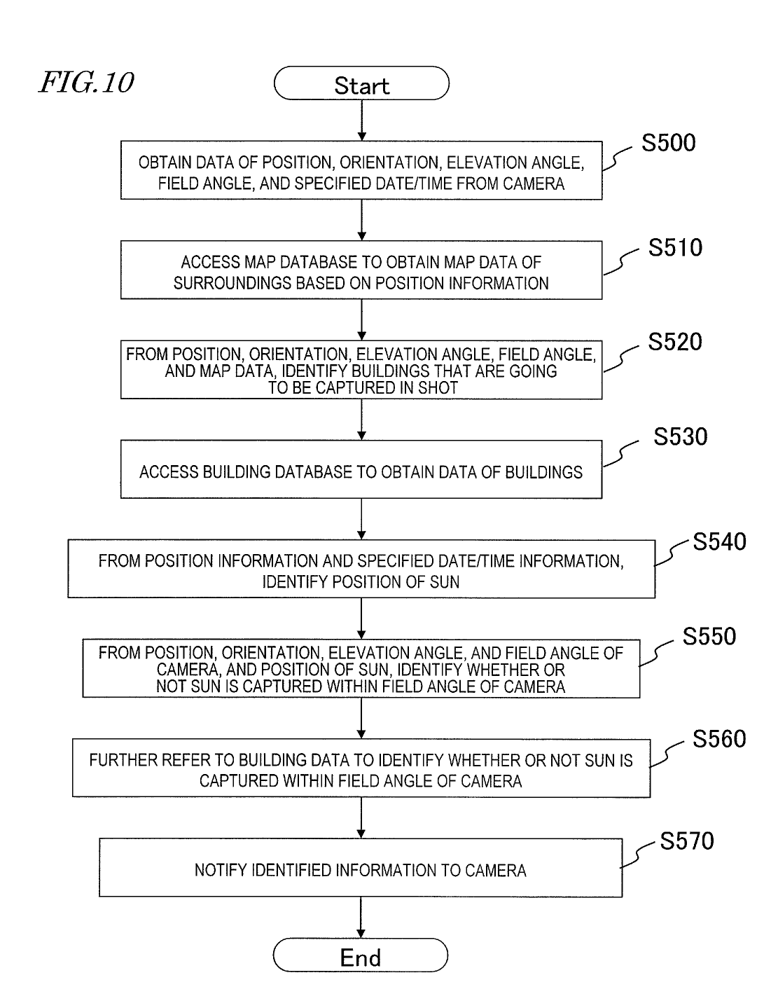

Processing executed by the information providing server 220 of this embodiment is described next with reference to a flow chart. FIG. 10 is a flow chart illustrating backlit shooting determining processing which is executed by the information providing server 220. In Step S500, the information providing server 220 holds communication to and from the camera 200 over the network 210 to obtain data of the current position, orientation, elevation angle, and field angle of the camera 200, and data of a specified date/time. In Step S510, the information providing server 220 next accesses the map database 230 via the network 210 to obtain map data of the surroundings of the camera based on the information of the current camera position. In Step S520, the information providing server 220 identifies buildings that are going to be captured in the shot based on the current position, orientation, elevation angle, and field angle of the camera, and the map data of the surroundings obtained from the map database 230. In Step S530, the information providing server 220 accesses the building database 240 to obtain data of the buildings identified in Step S520. In Step S540, the information providing server 220 identifies the position of the sun based on the current camera position information and the specified date/time information. In Step S550, the information providing server 220 identifies whether or not the sun is captured within the field angle of the camera based on the current position, orientation, elevation angle, and field angle of the camera, and the sun's position identified in Step S540. In Step S560, the information providing server 220 refers to the buildings' data obtained in Step S530 as well to identify whether or not the sun is captured within the field angle of the camera. Lastly, the information providing server 220 communicates to/from the camera 200 via the network 210 in Step S570 to notify the camera of the information identified in Step S560.

The control section 140 of FIG. 9 may display the information about backlit shooting on the image displaying section 130 in the form of a simple warning about backlit shooting. Instead, a concrete predicted position of the sun may be displayed superimposed on the current video on the screen.

[2-3. Effects and the Like]

As described, the information providing server 220 in this embodiment uses information of surrounding buildings and the solar orbit in addition to the position, orientation, elevation angle, and field angle of the camera 200 to accurately determine whether or not the location is backlit at a date/time specified by the user, and provides information indicating the result of the determination to the camera 200. This enables the user to avoid a situation where the shot taken in actual shooting is backlit.

This embodiment corresponds to Example 3 in FIG. 5. Therefore, the information providing server 220 may perform other determining operations of FIG. 5 in addition to the determining operations described above, and notify the results thereof to the camera 200. For instance, the camera 200 may be notified of a time at which, and the length of time till, the sun enters the shooting range, and a direction that puts the sun in the shooting range. Even when the sun is not captured within the shooting range at the specified time/date, there is a chance that the sun hinders shooting in the case where the sun enters the shooting range with the elapse of time, or in the case where the sun is situated just outside the shooting range. Displaying time information as those described above on the camera 200 so that such cases are avoided is effective in calling the user's attention.

### Third Embodiment

A third embodiment is described subsequently. This embodiment refers to an information providing system that provides a user with information for shooting the sun when the sun is to be shot intentionally on location. In this embodiment, the user is provided with various types of information about sunlight which is the “shooting object”. This embodiment is effective when shooting, for example, a sunrise scene, a sunset scene, or a solar eclipse. The following assumes a case where an information providing system assists in the shooting of a sunrise scene.

[3-1. Configuration]

The overall configuration of the information providing system in this embodiment is the same as the overall configuration of the second embodiment. The components of the information providing server 220 and the camera 200 are the same as those in the second embodiment as well. The following description focuses on differences from the second embodiment by omitting descriptions on matters common to the third embodiment and the second embodiment.

[3-2. Operation]

The operation of the camera 200 and the information providing server 220 in this embodiment is described.

The camera 200 transmits position information, orientation information, elevation angle information, field angle information, and specified date/time information which is set by the user to the network 210. Specifically, the control section 140 in the camera 200 transmits, via the network communication section 160, data detected respectively by the position sensor 180, the orientation sensor 182, the elevation angle sensor 184, the field angle detecting section 186, and the specified date/time information which is set by the user to the network 210. The data and the specified date/time information transmitted from the camera 200 are transmitted to the information providing server 220 via the network 210.

The information providing server 220 first accesses the map database 230 of FIG. 6 based on position information detected by the position sensor 180 to obtain map data of the vicinity of where the camera 200 is located. This map data includes data of the geography of the surroundings, in particular, geography and altitude data of the surroundings that affect a sunrise.

The information providing server 220 next identifies buildings that may be captured in the shot taken with the camera 200 based on the obtained map data, orientation information detected by the orientation sensor 182, elevation angle information detected by the elevation angle sensor 184, and field angle information detected by the field angle detecting section 186. The information providing server 220 then obtains data about the spatial layout in the three-dimensional space of the buildings that may be captured in the shot from the building database 240. The information providing server 220 can consequently grasp the heights of buildings in the perimeter of a video shot with the camera 200 and the positional relation of the buildings to the camera. The information providing server 220 can also grasp the heights of mountains or the like in the perimeter of a video shot with the camera 200 and the positional relation of the mountains or the like with respect to the camera, because the map data obtained from the map database 230 includes the geography and altitude data of the surroundings.

The information providing server 220 next uses the information of the position of the camera 200 detected by the position sensor 180 and the specified date/time information set by the user which is described above to obtain the position of the sun. The orientation and elevation angle of the sun can be identified if the position information and the date/time information are known. In this example where the shooting of a sunrise is assisted, in particular, the information providing server 220 calculates a time when the sun appears on the horizon that is closest to the specified date/time information set by the user, and the orientation and elevation angle of the rising sun.

The information providing server 220 compares the information of the identified orientation and elevation angle of the sun with the data of the orientation, elevation angle, and field angle of the camera 200 to determine whether or not the sunrise is within the field angle of the camera 200. The information providing server 220 which knows the heights and positional relation of buildings, mountains, or the like in the surroundings of the camera can accurately determine whether the sun rises from behind the buildings or the mountains that are captured in the shot taken with the camera 200. The information providing server 220 is further capable of detecting a differential amount which indicates how much the predicted sunrise is shifted from the current orientation, elevation angle, and field angle of the camera.

The information providing server 220 transmits the results of these determining operations as sunrise information to the camera 200 via the network 210. Specifically, the information providing server 220 transmits the information of the time of sunrise that is closest to the specified date/time information set by the user, the position information that indicates at which point in the current shooting range of the camera the sun is to rise, the information of a differential between the current orientation, elevation angle, and field angle of the camera and the predicted point at which the sun rises, or the like.

The control section 140 of the camera 200 obtains these pieces of sunrise information via the network communication section 160. The control section 140 displays a predicted time of sunrise on the image displaying section 130 based on the sunrise time information out of the received pieces of sunrise information. The user of the camera 200 can thus be informed of a time when the sun rises that is closest to the specified date/time information set by the user.

The control section 140 can also display a predicted position of sunrise on the image displaying section 130 based on the information about the sunrise position out of the received pieces of sunrise information. The user of the camera 200 can thus be informed of a point in the shooting range at which the sunrise is going to be captured.

The control section 140 is also capable of informing the user of the camera 200 of such information as an orientation, an elevation angle, and a field angle to which the camera is to be shifted in order to capture the sunrise by displaying a differential amount from the current position, elevation angle, and field angle, based on the information of a differential from the point at which the sun rises out of the received pieces of sunrise information.

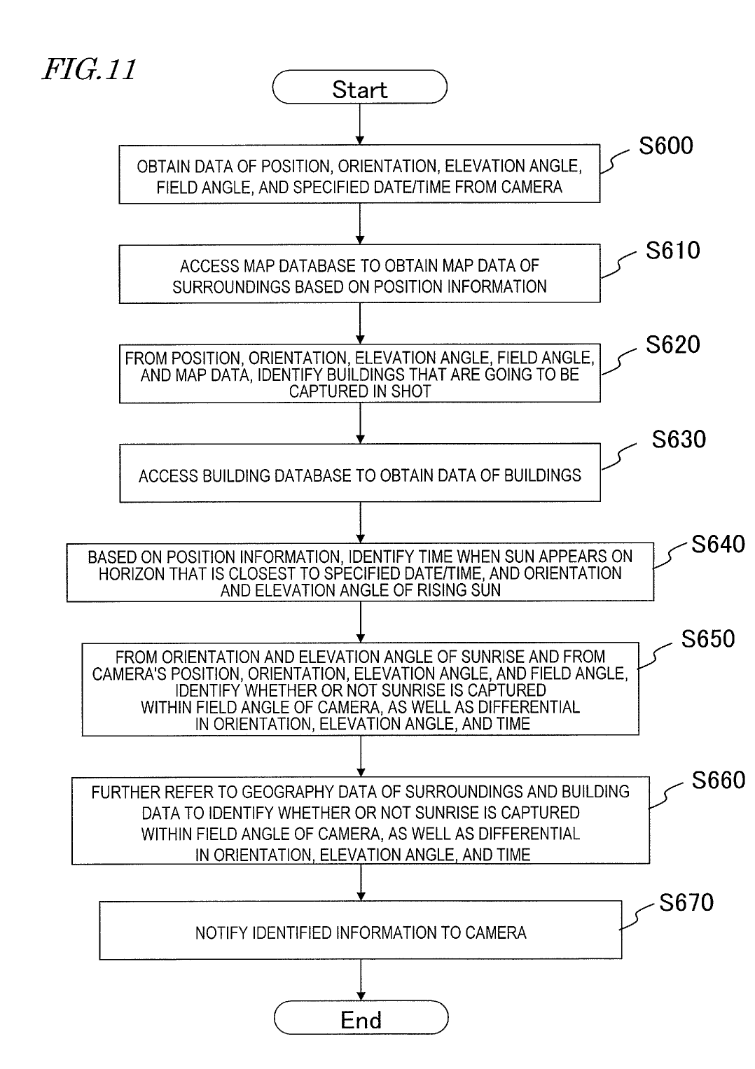

Processing executed by the information providing server 220 of this embodiment is described next with reference to a flow chart. FIG. 11 is a flow chart illustrating sunrise determining processing which is executed by the information providing server 220. In FIG. 6, in Step S600, the information providing server 220 holds communication to and from the camera over the network 210 to obtain data of the current position, orientation, elevation angle, and field angle of the camera, and data of a specified date/time. In Step S610, the information providing server 220 next accesses the map database 230 via the network 210 to obtain map data of the surroundings of the camera 200 based on the information of the current position of the camera 200. In Step S620, the information providing server 220 identifies buildings that are going to be captured in the shot based on the current position, orientation, elevation angle, and field angle of the camera, and the map data of the surroundings obtained from the map database 230. In Step S630, the information providing server 220 accesses the building database 240 to obtain data of the buildings identified in Step S620. In Step S640, the information providing server 220 identifies a time when the sun appears on the horizon that is closest to the specified date/time information, and the orientation and elevation angle of the rising sun based on the current position information of the camera 200 and the specified date/time information. In Step S650, the information providing server 220 identifies whether or not the sunrise is captured within the field angle of the camera 200 based on the current position, orientation, elevation angle, and field angle of the camera 200, and the orientation and the elevation angle of the sunrise identified in Step S640. In addition, the information providing server 220 identifies the differential amount between the current orientation, elevation angle, and field angle of the camera 200 and an orientation, an elevation angle, and a field angle with which the sunrise is going to be captured. The information providing server 220 further identifies the time at which sunrise is going to be captured. In Step S660, the information providing server 220 refers to the geography data of the map data obtained in Step S610 and the buildings' data obtained in Step S630 as well to identify whether or not the sunrise is captured within the field angle of the camera 200. In addition, the information providing server 220 identifies the differential amount between the current orientation, elevation angle, and field angle of the camera 200 and an orientation, an elevation angle, and a field angle with which the sunrise is going to be captured. The information providing server 220 further identifies the time at which sunrise is going to be captured. Lastly, the information providing server 220 communicates to/from the camera via the network 210 in Step S670 to notify the camera of the information identified in Step S660.

[3-3. Effects and the Like]

As described, the information providing server 220 in this embodiment provides the user with information for assisting in the intended shooting of the sun, such as the shooting of a sunrise. The user can thus shoot a sunrise with ease.

### Fourth Embodiment

A fourth embodiment is described next. This embodiment relates to an information providing system that provides a user with information by detecting, in advance, sunlight in location shooting, in particular, whether or not a location is in a shade at a date/time scheduled for shooting. In this embodiment, the user is provided with various types of information about a shade that is the “non-shooting object”.

[4-1. Configuration]

The overall configuration of the information providing system in this embodiment is the same as the overall configuration of the second embodiment. The components of the information providing server 220 are the same as those in the second embodiment. The following description focuses on differences from the second embodiment by omitting descriptions on matters common to the fourth embodiment and the second embodiment.

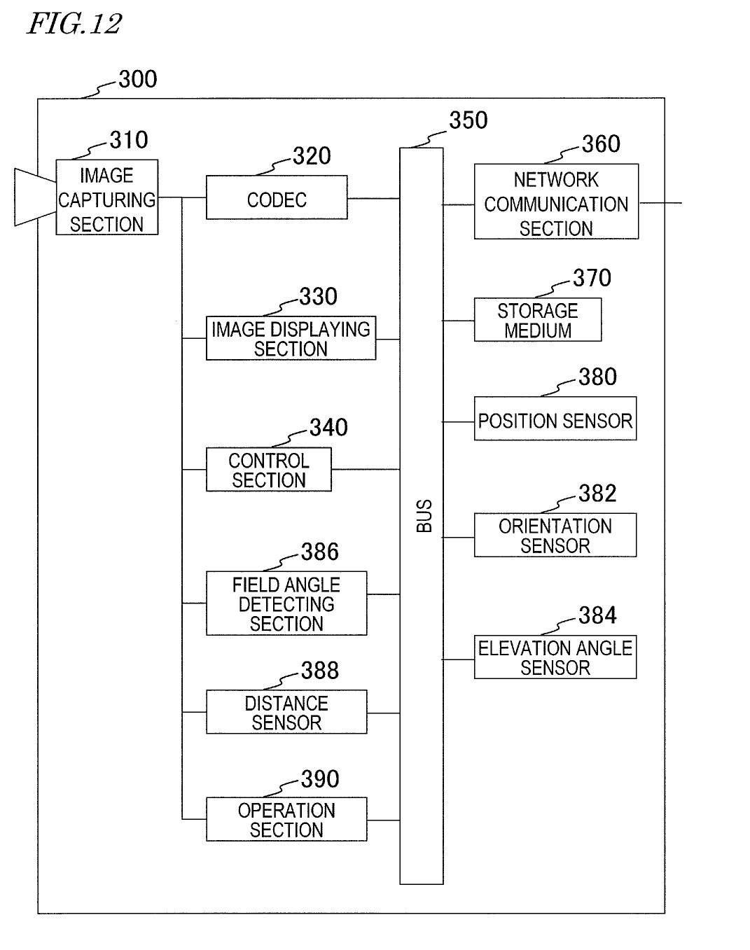

FIG. 12 is a block diagram illustrating the configuration of a camera 300 according to this embodiment. The camera 300 includes an image capturing section 310, a codec 320, an image displaying section 330, a control section 340, a bus 350, a network communication section 360, a storage medium 370, a position sensor 380, an orientation sensor 382, an elevation angle sensor 384, a field angle detecting section 386, a distance sensor 388, and an operation portion 390.

The camera 300 is substantially the same as the camera 200 described in the second embodiment with reference to FIG. 9, except for the addition of the distance sensor 388. The rest of the components are the same as the corresponding components in the first embodiment, and descriptions thereof are omitted here. A description on the operation of shooting and recording video which is the same as the operation of the camera 100 of FIG. 1 is also omitted here.

The distance sensor 388 is, for example, a ranging use-exclusive camera and detects the distance from the camera 300 to a subject. The ranging use-exclusive camera performs ranging by irradiating a subject with light from a light source that has a specific light emission pattern, and measuring the length of time till light reflected by the subject is detected. There are various methods of measuring a distance, for example, a ranging method that uses a laser as in laser range finders which are used in the field of robots, and a ranging method that uses supersonic waves or millimeter waves. How the distance is detected in this embodiment is not limited to a specific method.

A subject the distance from which is detected by the distance sensor 388 may herein be referred to as “main subject”. The main subject is a subject on which the camera 300 is focused manually by the user or automatically by the camera 300. The main subject is typically a person, animal, plant, or object around the center of the shooting range, or a person's face or conspicuous object that has been automatically detected.

[4-2. Operation]

The operation of the camera 300 and the information providing server 220 in this embodiment is described.

The control section 340 in the camera 300 transmits, via the network communication section 360, data indicating the position, orientation, elevation angle, field angle, and distance detected respectively by the position sensor 380, the orientation sensor 382, the elevation angle sensor 384, the field angle detecting section 386, and the distance sensor 388 to the network 210. The data transmitted from the camera 300 is transmitted to the information providing server 220 via the network 210.

In this embodiment, specified date/time information is used as in the second and third embodiments. The specified date/time information is a date/time set by the user of the camera 300 illustrated in FIG. 12. With a date/time for actual shooting or the like set by the user, the information providing server 220 checks how the sunlight looks at the scheduled time on the date of shooting. The control section 340 transmits the specified date/time information to the network 210 via the network communication section 360. At this point, the specified date/time information transmitted from the camera 100 is transmitted to the information providing server 220 via the network 210 in FIG. 2.

The information providing server 220 first accesses the map database 230 of FIG. 6 based on position information detected by the position sensor 380 to obtain map data of the vicinity of where the camera 300 is located. For instance, the information providing server 220 obtains map data of an area within a radius of several hundred meters to several kilometers from the position of the camera 300.

The information providing server 220 next identifies buildings that may be captured in the shot taken with the camera 300 and surrounding buildings that affect the shooting based on the obtained map data, orientation information detected by the orientation sensor 382, elevation angle information detected by the elevation angle sensor 384, and field angle information detected by the field angle detecting section 386. The information providing server 220 then obtains data about these buildings from the building database 240. The information providing server 220 can consequently grasp the heights of buildings in the perimeter of a video shot with the camera 300 and the positional relation of the buildings to the camera 300.

The information providing server 220 next uses the information of the position of the camera 300 which has been detected by the position sensor 380 and the specified date/time information set by the user which is described above to obtain the position of the sun. The orientation and elevation angle of the sun can be identified from the position information and the date/time information.

The information providing server 220 determines a range around the camera 300 that is in a shade from the information of the identified orientation and elevation angle of the sun, and from the information of the shape and heights of the surrounding buildings which is described above. The information providing server 220 then refers to distance information detected by the detection sensor 388 to determine whether or not the main subject of the camera 300 is going to be in a shade.

The information providing server 220 transmits the results of these determining operations to the camera 300 via the network 210. The control section 340 in the camera 300 receives the determination results via the network communication section 360. The control section 340 displays the determination results on the image displaying section 330 based on the received determination results, to thereby notifying the user of the camera 300 of whether or not the main subject is in a shade at the specified date/time.

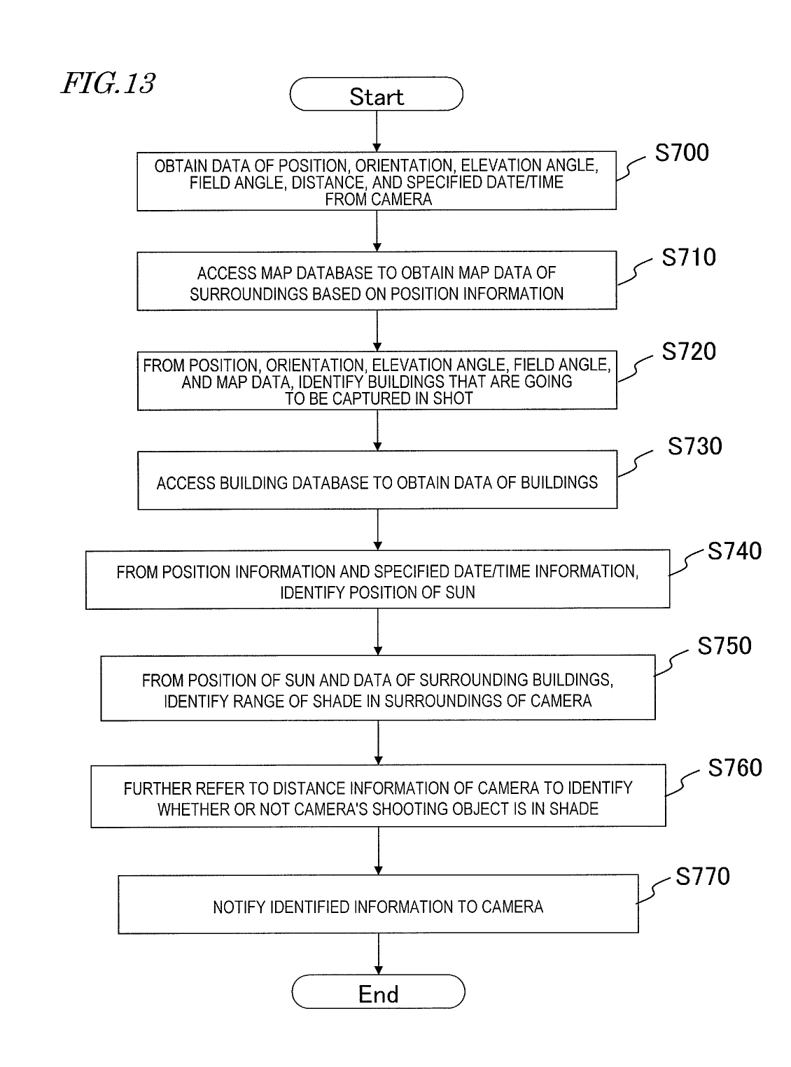

Processing executed by the information providing server 220 is described next with reference to a flow chart. FIG. 13 is a flow chart illustrating shade determining processing which is executed by the information providing server 220. In Step S700, the information providing server 220 holds communication to and from the camera 300 over the network 210 to obtain data of the current position, orientation, elevation angle, field angle, and distance of the camera 300, and data of a specified date/time. In Step S710, the information providing server 220 next accesses the map database 230 via the network 210 to obtain map data of the surroundings of the camera 300 based on the information of the current position of the camera 300. In Step S720, the information providing server 220 identifies buildings that are going to be captured in the shot taken with the camera 300 and buildings that affect the shooting based on the current position, orientation, elevation angle, and field angle of the camera 300, and the map data of the surroundings obtained from the map database 230. In Step S730, the information providing server 220 accesses the building database 240 to obtain data of the buildings identified in Step S720. In Step S740, the information providing server 220 identifies the position of the sun based on the current position information on the camera 300 and the specified date/time information. In Step S750, the information providing server 220 identifies the range around the camera that is in a shade based on the sun's position identified in Step S740 and the buildings' data obtained in Step S730. In Step S760, the information providing server refers to the distance information of the camera 300 as well to identify whether or not the shooting object of the camera is going to be in a shade. Lastly, the information providing server 220 communicates to/from the camera via the network in Step S770 to notify the camera 300 of the information identified in Step S760.

The control section 340 of FIG. 12 may display the determination results on the image displaying section 330 in the form of warning by simply displaying the result of determining whether or not the main subject is going to be in a shade, or may display other pieces of information about the shade. For instance, a video of a predicted shade may be generated and displayed. This is accomplished by adding a mechanism that transmits, in real time, a video compressed by the codec 320 of FIG. 12 to the network 210 via the network communication section 360. In this manner, a real time video is transmitted from the camera 300 to the information providing server 220. The information providing server 220 decodes the received video, further processes the video so that how the predicted shade looks is displayed, compresses the processed video, and sends the compressed video back to the camera 300. The camera 300 receives the video from the information providing server 220 via the network communication section 360, decodes the video with the codec 320, and displays the resultant video on the image displaying section 330. The user of the camera 300 can thus check how a shade looks in a video at the set date/time. This mode is effective because the information providing server 220 is generally higher in processing performance than the camera 300.

In this embodiment, the distance to the main subject is detected to determine whether or not the main subject is going to be in a shade. However, other modes than this may be employed. The information providing server 220 may simply determine whether or not a shade is within the shooting range, or may determine whether or not the proportion of the shade to the shooting range is higher than a given threshold.

[4-3. Effects and the Like]

As described above, this embodiment can provide information for assisting in shooting on location by detecting in advance whether a location is in a shade at a date/time specified by the user, or whether the main subject is going to be in a shade at the specified date/time. The user can thus avoid letting a location or the main subject be in a shade, and can accordingly prevent a change of location.

This embodiment corresponds to Example 5 in FIG. 5. Therefore, the information providing server 220 may perform other determining operations of FIG. 5 in addition to the determining operations described above, and notify the results thereof to the camera 200. For instance, the camera 300 may be notified of a time at which, or the length of time till, the motion of the sun puts the main subject in a shade, or the direction of the camera 300 that puts the main subject in a shade.

The functions in this embodiment described above can also be used when a shaded scene is shot intentionally. In this case, too, the camera 300 and the information providing server 220 operate the same way as above.

### Another Embodiment

The first to fourth embodiments have been described above as exemplification of the technique disclosed in this application. However, the technique disclosed herein is not limited thereto, and is also applicable to embodiments that are modified suitably by changing, replacing, adding, or omitting components, functions, or the like of the embodiments. A new embodiment may also be created by combining the components described in the first to fourth embodiments. Another embodiment is given below as exemplification.

In the second to fourth embodiments, where information related to sunlight is handled, suitability/unsuitability for shooting depends on weather conditions at the time of the shooting. For that reason, a weather information database may additionally be used in order to determine suitability/unsuitability for shooting based on weather forecasts and other types of information.

The image capture device and the information providing server may have at least two of the functions of the first to fourth embodiments so that a switch is made between the functions to one specified by the user. This is accomplished by, for example, configuring the operation section 390 in the image capture device 300 of FIG. 12 so that at least one of the shooting object and the non-shooting object can be set in addition to a date/time scheduled for shooting. With this configuration, the user can freely set at least one of the shooting object and the non-shooting object by operating the operation section 390. For instance, consider a case where the user specifies a vehicle of a public transportation system as the shooting object and specifies a shade as the non-shooting object. The control section 340 in this case transmits to the information providing server 220 information indicating the shooting object and the non-shooting object, in addition to such information as the position, direction, and field angle of the camera 300 and the shooting date/time. Receiving these pieces of information, the control section 34 (FIG. 2B) of the information providing server 220 executes, in parallel, the determining operations described in the first embodiment and the fourth embodiment, and transmits to the camera 300 the result of determination about whether or not the vehicle of the public transportation system is within the shooting range, the result of determination about whether or not the vehicle of the public transportation system is in a shade, and accompanying information. The camera 300 displays the information transmitted from the information providing server 220 on the image displaying section 330. The user can thus easily take actions to avoid a shade when shooting a vehicle of a public transportation system.

In each of the first to fourth embodiments, the functions of the embodiment are provided by the information providing system that includes the camera and the information providing server. Instead, the functions of the embodiment may be provided solely by the information providing device or the image capture device. An example of this embodiment is described below.

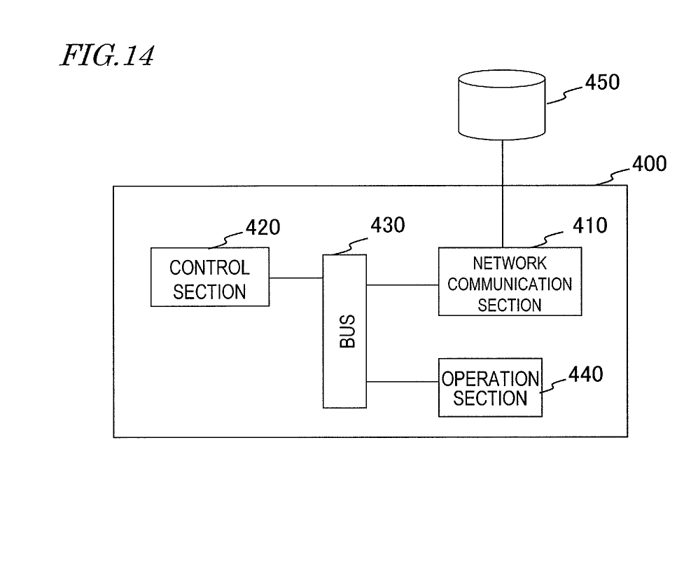

FIG. 14 is a block diagram illustrating a configuration example of an information providing device 400, which provides information for assisting in shooting to a user by itself. The information providing device 400 can be, for example, a computer set up in a studio or the like. The information providing device 400 includes a network communication section 410, an operation section (user interface) 440, a control section 420 that controls the above sections, and a bus 430 that electrically connects the above sections. The user uses the operation section 440 to input information that indicates the position and direction of the image capture device, thereby causing a display (not shown) to display information that indicates whether a desired shooting object or non-shooting object is within the shooting range, or similar information. The control section 420 at this point obtains data of the geography, buildings, a public transportation system, the sun, or the like from a storage medium 450 via the network communication section 410, determines whether or not the desired shooting object or non-shooting object is within the shooting range, and outputs the result of the determination. This configuration enables the user to grasp the situation of actual shooting with the use of only the information providing device 400 which is not premised on network connection to and from the camera. In this embodiment, the operation section 440 functions as an obtaining section. The network communication section 410 instead functions as the obtaining section in the case where the information of the position and direction of the image capture device is obtained via the network communication section 410.

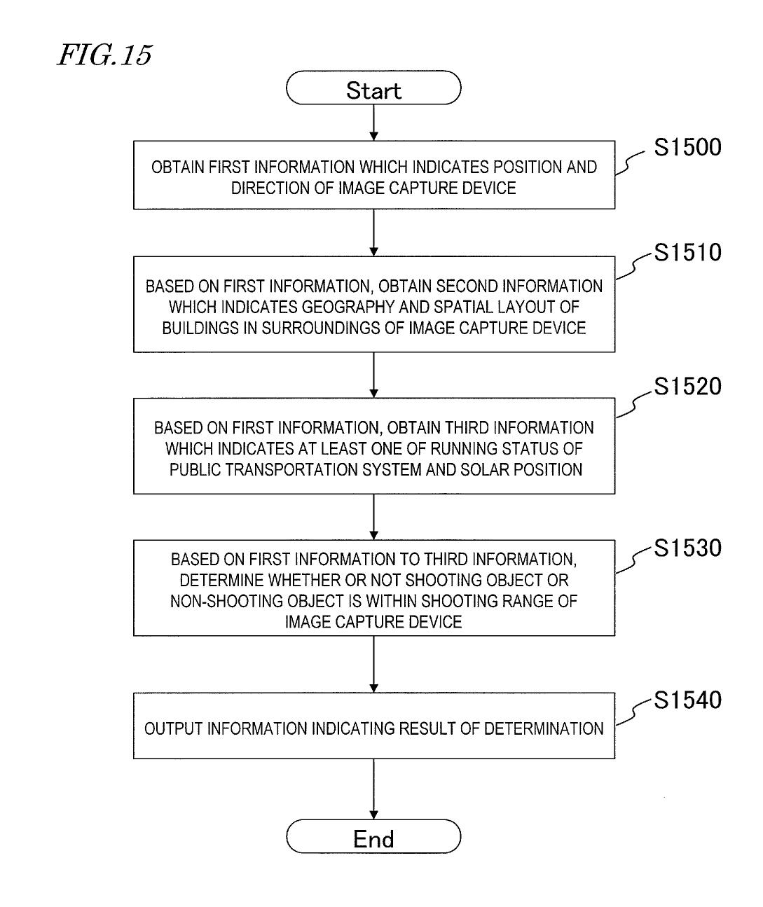

FIG. 15 is a flow chart outlining the operation of the control section 420 of the information providing device 400. First, the control section 420 obtains first information which indicates the position and direction of the image capture device (Step S1500). The control section 420 next obtains second information which indicates the geography and spatial layout of buildings in the surroundings of the image capture device, based on the first information (Step S1510). Subsequently, the control section 420 obtains third information, which indicates at least one of the running status of a public transportation system and the position of the sun, based on the first information (Step S1520). Based on the first information to the third information, the control section 420 determines whether or not the shooting object or the non-shooting object is within the shooting range of the image capture device (Step S1530). Lastly, information indicating the result of the determination is output (Step S1540). FIG. 15 illustrates only the basic operation, and the control section 420 may additionally perform accompanying operations which are not shown. For instance, the control section 420 may calculate and display such information as when the shooting object or the not-shooting object is to enter the shooting range, or how the direction of the image capture device is to be changed in order to put the shooting object or the non-shooting object inside the shooting range. The determining operation may be performed on the shooting object and the non-shooting object both.

Through the operation described above, the result of determination can be obtained by using only the information providing device 400, without needing the user to operate the camera. Accordingly, preliminary check for location shooting can easily performed without stepping out of, for example, a studio.

In the embodiments described above, the information providing device performs various types of determining processing and outputs the results of the determination. This operation may be performed by the image capture device instead. For that purpose, a device having the same functions as those of the information providing device is installed in the image capture device. The image capture device configured as this obtains necessary information such as the geography, buildings, the running status of a public transportation system, the solar orbit, and the like via the network on its own, performs necessary determining processing, and outputs the result of the determination to a display or the like. The user thus needs only the image capture device to obtain various types of information for assisting in location shooting.

The technique disclosed herein is not limited to the information providing systems, information providing devices, and image capture devices described above, and is also applicable to software (computer program) that defines processing in any one of the embodiments described above. The operation defined by this program is as illustrated in FIGS. 3, 8, 10, 11, 13, and 15, for example. This program may be provided by being recorded on a portable storage medium, or may be provided through a telecommunications line. A processor built inside the device executes the computer program, thereby implementing various operations in the embodiments described above.

The embodiments have now been described as exemplification of the technique disclosed herein. The accompanying drawings and the detailed description have been provided for that purpose.

Therefore, the components illustrated and described in the accompanying drawings and in the detailed description include not only ones indispensable for solving the problem but also ones that are not indispensable for solving the problem in order to exemplify the technique. These dispensable components should not be found to be indispensable just because the dispensable components are illustrated and described in the accompanying drawings and the detailed description.

The embodiments described above are for exemplification of the technique disclosed herein, and are susceptible of various changes, replacement, addition, omission, and the like within the scope of patent claims or an equivalent scope.

### INDUSTRIAL APPLICABILITY

The technique of the present disclosure is applicable to uses in which a user is provided with various type of information for assisting in shooting when, for example, location shooting is conducted.

### REFERENCE SIGNS LIST

10 image capture device
11 image capturing section
14 control section
15 bus
16 network communication section
19 detecting section
20 network
30 information providing device
34 control section
35 bus
36 network communication section
40 storage medium
100 camera
110 image capturing section
120 codec
130 image displaying section
140 control section
150 bus
160 network communication section
170 storage medium
180 position sensor
182 orientation sensor
184 elevation angle sensor
186 field angle detecting section
200 camera
210 network
220 information providing server
230 map database
240 building database
250 public transportation system database
300 camera
310 image capturing section
320 codec
330 image displaying section
340 control section
350 bus
360 network communication section
370 storage medium
380 position sensor
382 orientation sensor
384 elevation angle sensor
386 field angle detecting section
388 distance sensor
390 operation section
400 information providing device
410 network communication section
420 control section
430 bus
440 operation section
450 storage medium

1. An information providing system, comprising an image capture device and an information providing device that are connected to each other via a network,
the image capture device comprising:
a first network communication section configured to communicate via the network;
a detecting section configured to detect a position and direction of the image capture device; and
a first control section configured to transmit, to the information providing device, via the first network communication section, first information indicating the detected position and direction of the image capture device, and
the information providing device comprising:
a second network communication section configured to communicate via the network; and
a second control section configured to obtain, from a storage medium, based on the first information obtained by the second network communication section, second information indicating geography and spatial layout of buildings in surroundings of the image capture device, and third information indicating at least one of a running status of a public transportation system and a solar orbit, determines whether or not one of a shooting object and a non-shooting object is within a shooting range of the image capture device based on the first information to the third information, and transmits information indicating a result of the determination to the image capture device via the second network communication section.

2. The information providing system of claim 1,
wherein the image capture device further comprises a user interface that allows a user to specify a shooting date/time,
wherein the first control section transmits, to the information providing device, the first information and information indicating the shooting date/time specified by the user, and
wherein the second control section determines whether or not the one of the shooting object and the non-shooting object is within the shooting range at the specified shooting date/time.

3. The information providing system of claim 1,
wherein the third information comprises information indicating the running status of the public transportation system, and
wherein, when the one of the shooting object and the non-shooting object is a vehicle of the public transportation system, the second control section determines whether or not the vehicle of the public transportation system is within the shooting range of the image capture device based on the first information to the third information, and outputs information indicating a result of the determination to the image capture device.

4. The information providing system of claim 3, wherein, when determining that the vehicle of the public transportation system is not within the shooting range, the second control section determines whether or not the vehicle of the public transportation system passes through a vicinity of the image capture device, and transmits information indicating a result of the determination to the image capture device.

5. The information providing system of claim 3, wherein, when determining that the vehicle of the public transportation system is not within the shooting range, the second control section transmits, to the image capture device, information indicating one of a time at which the vehicle of the public transportation system enters the shooting range next, and how long till the vehicle of the public transportation system enters the shooting range next.

6. The information providing system of claim 1,
wherein the third information comprises information indicating the solar orbit, and
wherein, when the one of the shooting object and the non-shooting object is the sun, the second control section determines whether or not the sun is within the shooting range of the image capture device based on the first information to the third information, and transmits information indicating a result of the determination to the image capture device.

7. The information providing system of claim 6, wherein, when determining that the sun is not within the shooting range, the second control section transmits, to the image capture device, information indicating one of a time at which the sun enters the shooting range next, how long till the sun enters the shooting range next, and a direction of the image capture device that puts the sun inside the shooting range.

8. The information providing system of claim 1,
wherein the image capture device further comprises a distance sensor configured to detect a distance to a main subject,
wherein the first control section transmits fourth information indicating the detected distance to the main subject to the information providing device via the first network communication section,
wherein the third information comprises information indicating a position of the sun, and
wherein, when the non-shooting object is the main subject in a shade, the second control section determines whether or not the main subject is in a shade based on the first information to the fourth information, and transmits information indicating a result of the determination to the image capture device.

9. The information providing system of claim 1,
wherein the image capture device further comprises a user interface that allows a user to specify the one of the shooting object and the non-shooting object, and
wherein the first control section transmits information indicating one of the specified shooting object and the specified non-shooting object to the information providing device.

10. The information providing system of claim 1,
wherein the detecting section detects a position, orientation, elevation angle, and field angle of the image capture device, and
wherein the first control section transmits the first information that comprises information indicating the position, orientation, elevation angle, and field angle of the image capture device to the information providing device via the first network communication section.

11. An information providing device for use in the information providing system of claim 1.

12. (canceled)

13. An image capture device for use in the information providing system of claim 1.

14. (canceled)

15. An information providing method for use in an information providing system comprising an image capture device and an information providing device that are connected to each other via a network, the information providing method comprising:
obtaining first information indicating a position and direction of the image capture device;
obtaining, based on the first information, second information indicating geography and layout of buildings in surroundings of the image capture device;
obtaining, based on the first information, third information indicating at least one of a running status of a public transportation system and a solar orbit;
determining whether or not one of a shooting object and a non-shooting object is within a shooting range of the image capture device based on the first information to the third information; and
displaying information indicating a result of the determination on a display.
